(19) United States
(12) Patent Application Publication
(10) Pub. No.: US 2016/0095164 A1
(43) Pub. Date: Mar. 31, 2016

(54) HALOGEN HEATER

(71) Applicant: Toshiba Lighting & Technology Corporation, Kanagawa (JP)

(72) Inventor: Yoshitaka FUJITA, Yokosuka-shi (JP)

(21) Appl. No.: 14/791,688

(22) Filed: Jul. 6, 2015

(30) Foreign Application Priority Data
Sep. 30, 2014 (JP) 2014202330
May 13, 2015 (JP) 2015098317

(51) Int. Cl. H05B 3/00; H01K 7/00; H01K 1/28

(52) U.S. Cl. CPC H05B 3/009; H01K 1/28; H01K 7/00

(57) ABSTRACT

A heater of an embodiment includes a bulb, a filament, a gas, and metallic members. The filament is disposed in the inside portion of the bulb along a tube axis and includes a radiative unit and non-radiative units. The radiative unit performs radiation when applying current. The non-radiative units are disposed at either end of the radiative unit in a tube axis direction, are electrically connected to the radiative unit, and do not perform radiation relative to the radiative unit when applying current. The bulb includes a radiative region and non-radiative regions. The radiative unit is disposed in the radiative region. The non-radiative units are disposed in the non-radiative regions. The metallic members are disposed in the inside portion of the bulb, are thermally conductible, and are disposed in the non-radiative regions.

### CROSS-REFERENCE TO RELATED APPLICATIONS

This application is based upon and claims the benefit of priorities from Japanese Patent Application No. 2014-202330 filed on Sep. 30, 2014 and Japanese Patent Application No. 2015-098317 filed on May 13, 2015; the entire contents of which are incorporated herein by reference.

### FIELD

Embodiments described herein relate generally to a halogen heater.

### BACKGROUND

In the related art, when a halogen heater is powered up and is lighted, energy thereof is converted into heat, an infrared ray, or the like. In such a halogen heater, in order to secure effects of a smooth halogen cycle, the temperature of a bulb is maintained to be hundreds of degrees Celsius during lighting. Here, when a sealing section which is positioned at either end of the bulb in a tube axis direction has a specified temperature or above, there is concern that the sealing section of the halogen heater will be damaged.

In addition, in an irradiation apparatus which irradiates an irradiation target such as a semiconductor or a solar cell with heat, an infrared ray, or the like from a halogen heater mounted in the apparatus, a halogen heater which has an elongated non-radiative unit disposed on either end side in the tube axis direction is used in some cases in order to dispose the sealing section outside the apparatus.

In the halogen heater in which the elongated non-radiative units are disposed, a temperature is decreased in a bulb which is positioned in a non-radiative region in which the non-radiative unit is disposed. Therefore, there is concern that the temperature decrease of the bulb in the non-radiative region results in poor effects of the halogen cycle, a filament is consumed, and a bulb inner wall is blackened.

Exemplary embodiments aim to provide a halogen heater in which the temperature decrease of a bulb in a non-radiative region is suppressed.

### BRIEF DESCRIPTION OF THE DRAWINGS

FIG. 1 is a front view illustrating a halogen heater of Embodiment 1.

FIG. 2 is a view illustrating a main part of the halogen heater of Embodiment 1.

FIG. 3 is a front view illustrating a bulb.

FIG. 4 is a front view illustrating a filament.

FIG. 5 is a view illustrating a manufacturing procedure of the halogen heater of Embodiment 1.

FIG. 6 is a view illustrating a manufacturing procedure of the halogen heater of Embodiment 1.

FIG. 7 is a front view illustrating a halogen heater of Embodiment 2.

FIG. 8 is a view illustrating a main part of the halogen heater of Embodiment 2.

### DETAILED DESCRIPTION

Hereinafter, a halogen heater 1-1 or 1-2 of an embodiment includes a bulb 2, a filament 3, a gas 4, and metallic members 51 and 52. The filament 3 is disposed in an inside portion 2a of the bulb 2 along a tube axis. The filament 3 includes a radiative unit 31 and non-radiative units 32 and 33. The radiative unit 31 performs radiation when applying current. The non-radiative units 32 and 33 are disposed at either end of the radiative unit 31 in a tube axis direction, are electrically connected to the radiative unit 31, and do not perform radiation relative to the radiative unit 31 when applying current. The bulb 2 includes a radiative region P1 and non-radiative regions P2 and P3. The radiative unit 31 is disposed in the radiative region P1. The non-radiative units 32 and 33 are disposed in the non-radiative regions P2 and P3. The gas 4 fills the inside portion 2a of the bulb 2. The metallic members 51 and 52 are disposed in the inside portion 2a of the bulb 2. The metallic members 51 and 52 are thermally conductible. The metallic members 51 and 52 are disposed in the non-radiative regions P2 and P3.

In addition, in the halogen heater 1-1 or 1-2 of the embodiment to be described below, the non-radiative units 32 and 33, the metallic members 51 and 52 are disposed to overlap each other in a radial view, the non-radiative units 32 and 33 are 5 cm or greater in length in the tube axis direction, the metallic members 51 and 52 are 5 cm or greater in length in the tube axis direction and the non-radiative units 32 and 33 and the metallic members 51 and 52 are set to have substantially the same length in the tube axis direction.

In addition, in the halogen heater 1-1 or 1-2 of the embodiment to be described below, the metallic member 51 and 52 are configured as closely wound coils.

In addition, in the halogen heater 1-1 of the embodiment to be described below, the radiative unit 31 is a coil which is formed by winding a wire and the non-radiative units 32 and 33 are each a metallic bar which is greater in diameter than the wire.

In addition, in the halogen heater 1-1 or 1-2 of the embodiment to be described below, the radiative unit 31 and the non-radiative units 32 and 33 are configured as separate members.

In addition, in the halogen heater 1-1 or 1-2 of the embodiment to be described below, the non-radiative units 32 and 33 and the metallic members 51 and 52 are disposed to overlap each other in a radial view, the non-radiative units 32 and 33 are 5 cm to 30 cm in length in the tube axis direction, the metallic members 51 and 52 are 5 cm to 30 cm in length in the tube axis direction, and the non-radiative units 32 and 33 and the metallic members 51 and 52 are set to have substantially the same length in the tube axis direction.

In addition, in the halogen heater 1-1 or 1-2 of the embodiment to be described below, the non-radiative units 32 and 33 and the metallic members 51 and 52 are formed to have a difference in length within 1 cm in the tube axis direction.

### Embodiment 1

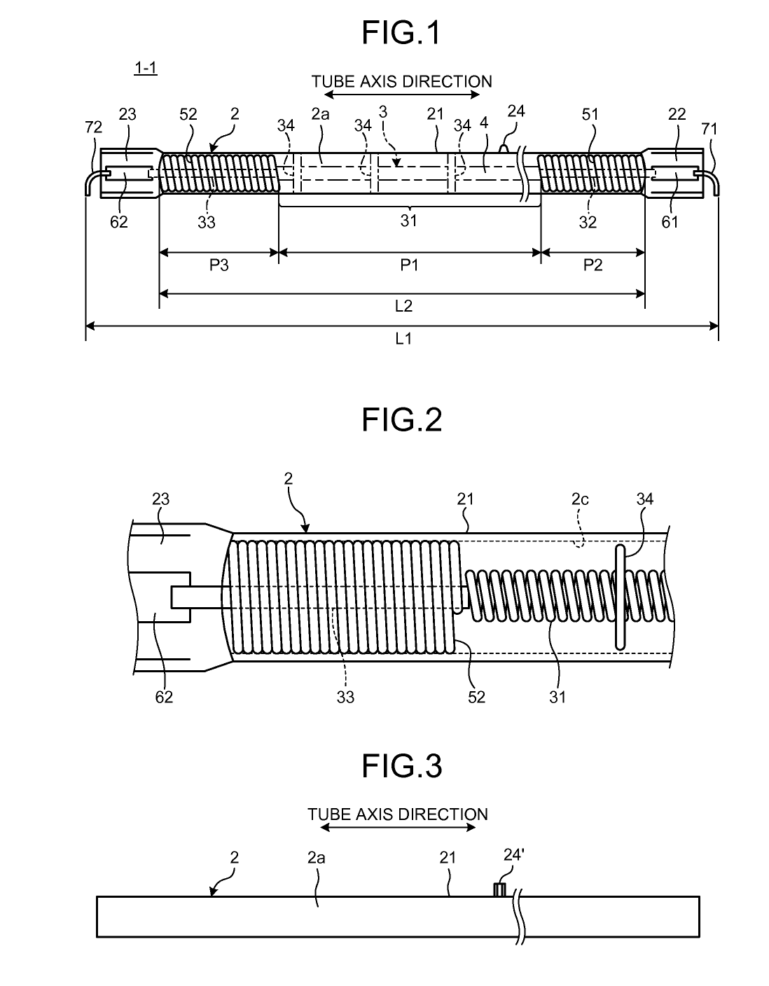

The embodiment is described with reference to FIG. 1 and FIG. 2. FIG. 1 is a front view illustrating a halogen heater of Embodiment 1. FIG. 2 is a view illustrating a main part of the halogen heater of Embodiment 1.

A halogen heater of Embodiment 1 supplies heat to an object or space which is a target to be heated and as an example, a case in which the halogen heater is used as a heat source disposed in a heating furnace for manufacturing a semiconductor, a solar cell or the like. As illustrated in FIG. 1, the halogen heater 1-1 (hereinafter, simply referred to as a “heater 1-1”) is configured to include the bulb 2, the filament 3, the gas 4, the metallic members 51 and 52, the metallic foils 61 and 62, and outer leads 71 and 72.

The bulb 2 is configured to include a cylinder-like section 21, the sealing sections 22 and 23, and a tip 24. For example, the bulb 2 is formed of quartz glass, is transparent and color free, and is an elongated object in which an entire length L1 is longer compared to a tube diameter. The bulb 2 has a bulb wall loading of 21.3 [W/cm²].

The cylinder-like section 21 has the inside portion 2a as an inside space and the filament 3 is disposed in the inside portion 2a thereof.

The sealing sections 22 and 23 are each disposed at either end of the bulb 2 in the tube axis direction. The sealing sections 22 and 23 are adhesion-sealing sections and seal the cylinder-like section 21. The sealing sections 22 and 23 in Embodiment 1 are formed to have a plate shape through pinch sealing. The sealing sections 22 and 23 may be formed to be columnar through shrink sealing.

The tip 24 is a burned and cut mark of a discharge tube 24′ (refer to FIG. 3) which is provided so as to perform discharge from the inside portion 2a and the gas 4 is sealed therein during manufacturing of the heater 1-1. The tip 24 is closed when the manufacturing of the heater 1-1 is completed.

In addition, the bulb 2 in Embodiment 1 includes a radiative region P1 and non-radiative regions P2 and P3. In the inside portion 2a (that is inside space) of the cylinder-like section 21 of the bulb 2, the radiative region P1 is a region in which the radiative unit 31 to be described below becomes radiative when applying current to the filament 3 and a region of the inside portion 2a partitioned in the tube axis direction. The radiative region P1 in Embodiment 1 is disposed at the center of the cylinder-like section 21 in the tube axis direction. The radiative region P1 has a width the same as the length of the radiative unit 31 in the cylinder-like section 21 in the tube axis direction. In the inside portion 2a (that is inside space) of the cylinder-like section 21 of the bulb 2, the non-radiative regions P2 and P3 are regions in which the non-radiative units 32 and 33 to be described below are not radiative when applying current to the filament 3 and regions of the inside portion 2a partitioned in the tube axis direction. The non-radiative regions P2 and P3 in Embodiment 1 are each positioned at either end of the radiative region P1 in the tube axis direction of the cylinder-like section 21 and are disposed between the radiative region P1 and the sealing sections 22 and 23 in the tube axis direction. The non-radiative regions P2 and P3 have a width the same as the length of the non-radiative units 32 and 33 in the cylinder-like section 21 in the tube axis direction.

The filament 3 is disposed in the inside portion 2a of the bulb 2 along the tube axis. The filament 3 is formed integrally with the radiative unit 31, the non-radiative units 32 and 33, and the anchor 34.

The radiative unit 31 is a main part in the filament 3 and is a section which generates heat and becomes radiative when applying current. The radiative unit 31 is disposed in the inside portion 2a of the cylinder-like section 21. The radiative unit 31 is a coil which is formed by spirally winding a tungsten wire. The radiative unit 31 is formed to be circular in a tube axis view. That is, the radiative unit 31 is formed to be cylindrical.

The non-radiative units 32 and 33 are portions that are not radiative relative to the radiative unit 31 when applying current. The non-radiative units 32 and 33 are configured as members separate from the radiative unit 31. The non-radiative units 32 and 33 each have one end which is electrically connected to either end portion of the radiative unit 31 and the other end which is electrically connected to each of the metallic foils 61 and 62. As illustrated in FIG. 2, the non-radiative units 32 and 33 are each a metallic bar which is greater in diameter than the tungsten wire configuring the radiative unit 31. The non-radiative units 32 and 33 in Embodiment 1 are metallic rods which are formed of tungsten extending in a tube axial view. In addition, the non-radiative units 32 and 33 are formed to have a round bar shape extending along the tube axis of the bulb 2.

Here, the non-radiative units 32 and 33 are not radiative relative to the radiative unit 31 when applying current, which means that the non-radiative units 32 and 33 are in a state which is darker than the radiative unit 31 when applying current to the filament 3 and preferably, that the non-radiative units 32 and 33 are in a state in which radiation thereof is not observed.

In addition, a bar diameter of the non-radiative units 32 and 33 in Embodiment 1 is formed to be greater than the diameter of the wire of the radiative unit 31 to the extent that the non-radiative units 32 and 33 are not radiative when applying current such that electrical resistance becomes low by the radiative unit 31. In addition, since the non-radiative units 32 and 33 are metallic bars extending in the tube axis direction relative to the radiative unit 31 (that is, a coil formed by being spirally wound), the non-radiative units 32 and 33 have low electrical resistance by the radiative unit 31.

In addition, it is preferable that the non-radiative units 32 and 33 are set to be 5 cm to 30 cm in length in the tube axis direction.

Here, the non-radiative units 32 and 33 are 5 cm or greater in length in the tube axis direction. This is because the inner wall 2c of the bulb 2 is unlikely to be blackened even when the metallic members 51 and 52 are not provided and a temperature decrease of the non-radiative units 32 and 33 is hardly observed when the length is less than 5 cm. In addition, the non-radiative units 32 and 33 are 30 cm or less in length in the tube axis direction. This is because, when the length exceeds 30 cm, a lower thermal conduction effect is achieved from the metallic members 51 and 52 even when the metallic members 51 and 52 are provided and thus, there is concern that blackening of the inner wall 2c of the bulb 2 will not be easily suppressed.

As illustrated in FIG. 1 and FIG. 2, the anchor 34 is a member that supports the radiative unit 31 from the inner wall 2c of the bulb 2 and a support member of the radiative unit 31. The anchor 34 is configured as a member separate from the radiative unit 31 and the non-radiative units 32 and 33. The anchor 34 has one end portion which is wound several times around the circumference of the radiative unit 31 and is connected to the radiative unit 31. The anchor 34 has the center portion which is formed toward the inner wall 2c of the bulb 2. The anchor 34 has an arc shape in the tube axial view such that the other end portion thereof is disposed along the inner wall 2c. One or more anchors 34 are provided in plurality in the tube axis direction so as to maintain a predetermined pitch and support the radiative unit 31 of the filament 3 such that the radiative unit 31 is positioned substantially at the center of the inside portion 2a of the bulb 2 in the radial direction. In this manner, contact or approaching of the entire radiative unit 31 to the inner wall 2c of the bulb 2 can be suppressed.

The inside portion 2a of the bulb 2 is filled with the gas 4. The gas 4 in Embodiment 1 is argon gas at substantially 0.8 atm in which a trace of dibromomethane (CH₂Br₂) is contained. Specifically, the gas 4 may be configured to contain an inert gas which consists of any one type or a combination of a plurality of types of krypton, xenon, argon, and neon. Further, the gas 4 may be configured to contain a halogen substance which consists of one type or a combination of a plurality of types of bromine or iodine.

The metallic members 51 and 52 are disposed in the non-radiative regions P2 and P3, respectively, in the inside portion 2a of the cylinder-like section 21. The metallic members 51 and 52 are thermally conductible metallic members and are metallic members which conduct heat generated from the radiative unit 31 to the bulb 2 in the non-radiative regions P2 and P3 when applying current. The metallic members 51 and 52 in Embodiment 1 are each configured as a coil which is formed by spirally winding a metallic wire of molybdenum. The metallic members 51 and 52 are formed to be circular in the tube axial view. That is, the metallic members 51 and 52 are formed to be cylindrical. The metallic members 51 and 52 each have an inner coil diameter which is formed to be greater than the bar diameter of the non-radiative units 32 and 33 and an outer coil diameter of the radiative unit 31. In this manner, the metallic members 51 and 52 are disposed between the inner wall 2c of the bulb 2 in the radial direction and the non-radiative units 32 and 33 and are disposed to overlap the non-radiative units 32 and 33 in the radial view. The metallic members 51 and 52 are disposed adjacent to the sealing sections 22 and 23 in the tube axis direction.

In addition, the metallic members 51 and 52 have an outer coil diameter greater than the inner diameter (hereinafter, simply referred to as a “inner bulb diameter”) of the bulb 2 within a range in which the metallic members are elastically deformed in the radial direction and can be disposed in the inside portion 2a of the bulb 2. In this manner, the metallic members 51 and 52 are pressed in the inside portion 2a of the bulb 2 and the outer circumferences of the metallic members 51 and 52 come into elastic contact with the inner wall 2c of the bulb 2.

The metallic members 51 and 52 pressed in the inside portion 2a of the bulb 2 conduct the heat to the inner wall 2c of the bulb 2 in the non-radiative regions P2 and P3 which come into contact with the outer circumferences of the metallic members 51 and 52. In addition, since the metallic members 51 and 52 are pressed in the inside portion 2a of the bulb 2, the movement of the metallic members 51 and 52 are regulated in the tube axis direction.

In addition, it is preferable that the metallic members 51 and 52 are configured to be closely wound coils. Here, in a state in which the metallic members 51 and 52 are disposed in the inside portion 2a of the bulb 2, the closely wound coils have spirally wound metallic wires which come into contact with each other in the tube axis direction. When the metallic wires of the closely wound coils come into contact with each other in the tube axis direction, a contact area between the inner wall 2c and the outer circumferences of the metallic members 51 and 52 becomes greater than in a case of configuring the metallic members 51 and 52 using loosely wound coils in which spirally wound metallic wires are spaced apart in the tube axis direction. In this manner, an area from which the heat generated by the radiative unit 31 is conducted to the bulb 2 in the non-radiative regions P2 and P3 is increased.

In addition, even when the radiative unit 31 and the non-radiative units 32 and 33 come into electrical contact with each other and the current is applied to the metallic members 51 and 52, a wire diameter of the closely wound coil is formed to be greater than the wire diameter of the radiative unit 31 such that the metallic members 51 and 52 are not radiative similar to the non-radiative units 32 and 33. Accordingly, the metallic members 51 and 52 have an electric resistance value lower than that of the radiative unit 31.

In addition, it is preferable that the metallic members 51 and 52 are 5 cm or greater in length in the tube axis direction. Here, the metallic members 51 and 52 are 5 cm or greater in length in the tube axis direction. This is because, when the length is less than 5 cm, a lower thermal conduction effect is achieved from the metallic members 51 and 52 even when the metallic members 51 and 52 are provided and thus, there is concern that blackening of the inner wall 2c of the bulb 2 will not be easily suppressed.

In addition, it is preferable that the non-radiative units 32 and 33 and the metallic members 51 and 52 are set to have substantially the same length in the tube axis direction.

Here, the non-radiative units 32 and 33 and the metallic members 51 and 52 are set to have substantially the same length in the tube axis direction. This is because, when the metallic members 51 and 52 are shorter than the non-radiative units 32 and 33 in the tube axis direction, a portion at which the non-radiative units 32 and 33 and the metallic members 51 and 52 overlap each other in the radial view becomes small and thus, there is concern that at least one part of the bulb 2 in the non-radiative regions P2 and P3 will have a lower tube wall temperature. In addition, when the metallic members 51 and 52 are longer than the non-radiative units 32 and 33 in the tube axis direction, at least one part of each of the metallic members 51 and 52 are overlapped with the radiative unit 31 in the radial view, at least one part of the radiative unit 31 is blocked by the metallic members 51 and 52, and thus, there is concern that the radiative unit 31 will have low radiative efficiency in the direction of an irradiation target.

According to Embodiment 1, when the non-radiative units 32 and 33 and the metallic members 51 and 52 have substantially the same length in the tube axis direction, a halogen cycle in the non-radiative regions P2 and P3 is promoted due to the length of the non-radiative units 32 and 33 and the metallic members 51 and 52 in the tube axis direction and the length is set in a range in which reduction of the radiative efficiency of the bulb 2 in the radiative region P1 is suppressed. According to Embodiment 1, the lengths of the non-radiative units 32 and 33 and the metallic members 51 and 52 are set in a range of 5 cm to 30 cm with an error range of ±1 cm apart from each other in the tube axis direction. In this manner, a manufacturing error of ±1 cm is permitted.

As illustrated in FIG. 1, the metallic foils 61 and 62 each have one end which is electrically connected to each of the non-radiative units 32 and 33 and each have the other end which is electrically connected to each of the outer leads 71 and 72. The metallic foils 61 and 62 are buried inside the sealing sections 22 and 23. The metallic foils 61 and 62 according to Embodiment 1 are molybdenum foils and are disposed so as to be positioned along the plate-like surface of the sealing sections 22 and 23.

The outer leads 71 and 72 are connected to the metallic foils 61 and 62 and an external power source (not illustrated). The outer leads 71 and 72 each have one end which is electrically connected to each of the metallic foils 61 and 62 and the other end which is exposed to the outside of the bulb 2. A part of each of the outer leads 71 and 72 is buried in each of the sealing sections 22 and 23. The other end of each of the outer leads 71 and 72 is inserted into a connector (not illustrated) together with the sealing sections 22 and 23, is electrically connected to a cable (not illustrated) provided in the connector, and is connected to the power source through the cable. The outer leads 71 and 72 according to Embodiment 1 are molybdenum bars.

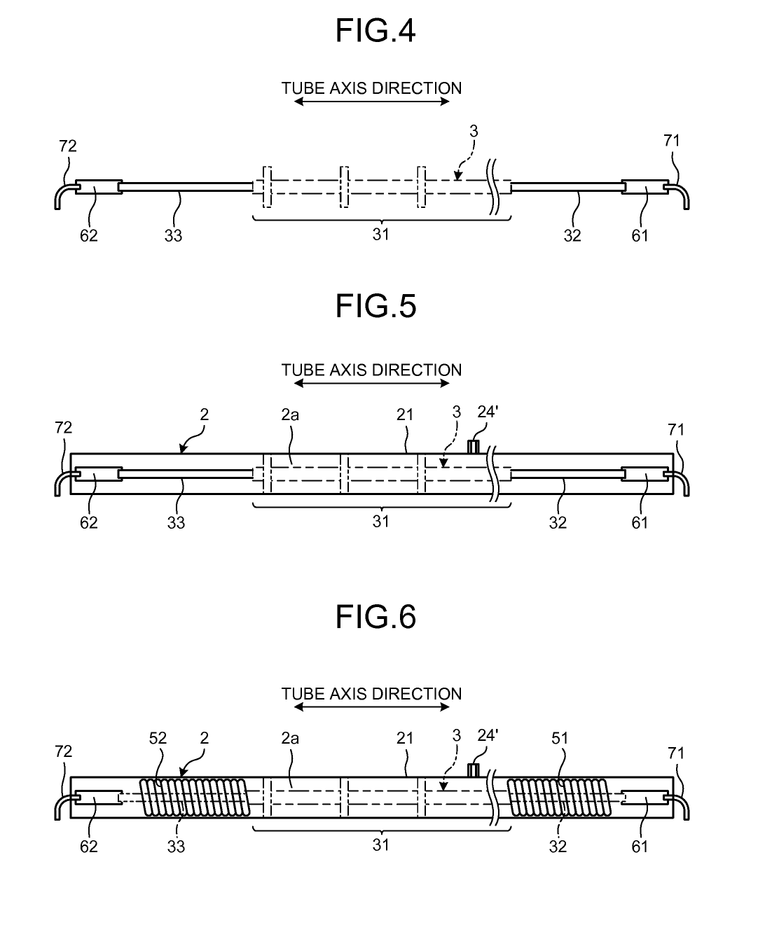

Next, a manufacturing procedure of the heater 1-1 will be described. FIG. 3 is a front view illustrating the bulb. FIG. 4 is a front view illustrating the filament. FIG. 5 and FIG. 6 are views illustrating the manufacturing procedure of the halogen heater of Embodiment 1.

As illustrated in FIG. 3, before processing, the entire bulb 2 is formed of the cylinder-like section 21 and the inside portion 2a and the outside of the bulb 2 communicate through a discharge pipe 24′. In a direction as illustrated in FIG. 4, the filament 3 are connected to the metallic foils 61 and 62 and the outer leads 71 and 72 through welding or the like therebetween.

In addition, as illustrated in FIG. 5, the filament 3 is inserted into the inside portion 2a of the bulb 2. At this time, the filament 3 is inserted into the inside portion 2a of the bulb 2 such that the metallic foils 61 and 62 are positioned at predetermined positions at which the sealing portions of the sealing sections 22 and 23 are formed.

Next, as illustrated in FIG. 6, the metallic members 51 and 52 is pressed into the inside portion 2a from either end of the bulb 2. At this time, the metallic members 51 and 52 are pressed into the inside portion 2a of the bulb 2 such that the metallic members 51 and 52 are positioned at positions adjacent to the sealing portions to be formed to the center side in the tube axis direction from the predetermined position at which the sealing portions of the sealing sections 22 and 23 are formed.

Next, either end of the bulb 2 is melted using a gas burner (not illustrated), the end is pinched with a pincher (not illustrated), and the sealing sections 22 and 23 (refer to FIG. 1) are formed. In this manner, the filament 3 and the metallic members 51 and 52 are accommodated in the cylinder-like section 21.

Next, air in the cylinder-like section 21 is discharged through the discharge pipe 24′ and the gas 4 is sealed therein.

Next, the discharge pipe 24′ is melted using the gas burner (not illustrated) and is cut, the cylinder-like section 21 is closed, and the inside portion 2a of the bulb 2 is filled with the gas 4 (refer to FIG. 1).

Next, an example of manufacturing of the heater 1-1 will be described. The heater 1-1 has an entire length L1 of 510 mm, a bulb tube diameter of 10 mm, an inner bulb diameter of 8 mm, an effective radiation length L2 of 480 mm, a length of the radiative region P1 of 280 mm in the tube axis direction, and a length of each of the non-radiative regions P2 and P3 of 100 mm in the tube axis direction. In addition, the heater 1-1 has a length of the radiative unit 31 of 280 mm in the tube axis direction (the same as the radiative region P1), an outer coil diameter of the radiative unit 31 of 5 mm, a wire diameter of the radiative unit 31 of 0.2 mm to 0.5 mm, a length of each of the non-radiative units 32 and 33 of 100 mm in the tube axis direction (the same as the non-radiative regions P2 and P3), and a bar diameter of the non-radiative units 32 and 33 of 0.5 mm to 1.2 mm (greater than the wire diameter of the radiative unit 31). In addition, the heater 1-1 has a length of each of the metallic members 51 and 52 of 100 mm (the same as the non-radiative units 32 and 33), an outer coil diameter of the metallic members 51 and 52 of 8 mm, and a wire diameter of the metallic members 51 and 52 of 0.6 mm.

In addition, when heater power is 1500 W, the heater 1-1 has a tube wall loading of 21.3 W/cm², a heater voltage of 235 V, and a heater current of 6.4 A. The tube wall loading is a value obtained by dividing the heater power by the inner surface area of the bulb 2 and the inner surface area of the bulb 2 is obtained by inner bulb diameter [mm]×3.14 (Pi)×effective radiation length L2 [mm].

Next, an operation of the heater 1-1 will be described. Power is supplied to the heater 1-1 through the outer leads 71 and 72 from the outside. When the power is supplied to the heater 1-1, the radiative unit 31 of the filament 3 and the non-radiative units 32 and 33 are applied with current in the tube axis direction. Accordingly, the radiative unit 31 becomes radiative and the non-radiative units 32 and 33 are not radiative relative to the radiative unit 31. In addition, in the radiative region P1, the tube wall temperature of the bulb 2 becomes a temperature at which the halogen cycle is promoted, due to the heat generated from the radiative unit 31. In addition, the heat generated from the radiative unit 31 is conducted to the non-radiative regions P2 and P3 through the metallic members 51 and 52 and the heat is conducted to the inner wall 2c of the bulb 2 in the non-radiative regions P2 and P3. The heat is conducted to the inner wall 2c of the bulb 2 from the metallic members 51 and 52 and thereby, the tube wall temperature of the bulb 2 in the non-radiative regions P2 and P3 becomes the temperature at which the halogen cycle is promoted. In addition, since the contact area is great between the inner wall 2c of the bulb 2 in the non-radiative regions P2 and P3 and the metallic members 51 and 52 configured of the closely wound coil, the thermal conduction efficiency to the inner wall 2c of the bulb 2 from the metallic members 51 and 52 is improved. Therefore, in the heater 1-1, the temperature decrease of the bulb 2 in the non-radiative regions P2 and P3 can be suppressed.

In addition, if an irradiation target is heated using the heater 1-1 mounted in a heating furnace, the heater 1-1 is supplied with power through the outer leads 71 and 72 from the outside when the non-radiative regions P2 and P3 are disposed on outer side of the heating furnace and the radiative unit 31 generates heat and becomes radiative. In addition, the radiative region P1 and the non-radiative regions P2 and P3 have the tube wall temperature of the bulb 2 which reaches the temperature at which the halogen cycle is promoted. In addition, the non-radiative units 32 and 33 and the metallic members 51 and 52 are 5 cm or greater in length in the tube axis direction in the sealing sections 22 and 23. Therefore, in the heater 1-1, the temperature decrease of the bulb 2 in the non-radiative regions P2 and P3 can be suppressed.

In addition, since the metallic members 51 and 52 provided in the heater 1-1 are configured as closely wound coils, the temperature decrease of the bulb 2 in the non-radiative regions P2 and P3 can be suppressed.

In addition, since the radiative unit 31 provided in the heater 1-1 is the coil formed of winding a wire and the non-radiative units 32 and 33 are the metallic bars having a diameter greater than the wire, the temperature decrease of the bulb 2 in the non-radiative regions P2 and P3 can be suppressed.

In Embodiment 1 described above, the non-radiative units 32 and 33 are the metallic bars having a diameter greater than the wire of the radiative unit 31; however, as long as the non-radiative units 32 and 33 are not radiative relative to the radiative unit 31 when applying current, the non-radiative units 32 and 33 may be configured to have an electrical resistance value less than the radiative unit 31. Therefore, the non-radiative units 32 and 33 may be metallic wires having a diameter greater than the diameter of the wire of the radiative unit 31.

In addition, according to Embodiment 1 described above, the metallic members 51 and 52 are configured as closely wound coils; however, as long as the tube wall temperature of the bulb 2 in the non-radiative regions P2 and P3 is the temperature at which the halogen cycle is promoted, for example, the metallic members 51 and 52 may be configured as a metallic tube or the like formed to be cylindrical in the tube axial view. In this case, the metallic members 51 and 52 can be inserted into the inside portion 2a of the bulb 2 and thus, it is preferable that the metallic members 51 and 52 are formed to have an outer diameter with which thermal conduction to the inner wall 2c of the bulb 2 in the non-radiative regions P2 and P3 can be performed.

In addition, according to Embodiment 1, the metallic members 51 and 52 are pressed into the inside portion 2a of the bulb 2; however, the outer diameter of the metallic members 51 and 52 may be formed to be less than the inner bulb diameter when the tube wall temperature of the bulb 2 in the non-radiative regions P2 and P3 can be maintained to be the temperature at which the halogen cycle is promoted. In this case, it is preferable that the metallic members 51 and 52 are fixed directly to the non-radiative units 32 and 33 or the like, for example, such that the movement of the metallic members 51 and 52 is regulated in the tube axis direction or the anchor 34 or the like is disposed at an end portion of the metallic members 51 and 52 on a side opposite to the sealing sections 22 and 23. When the outer diameter of the metallic members 51 and 52 is formed to be less than the inner bulb diameter, the metallic members 51 and 52 can be simply inserted into the inside portion 2a of the bulb 2.

In addition, in the embodiment described above, at least one end of each of the metallic members 51 and 52 in the tube axis direction is not in electrical contact with the radiative unit 31 or the non-radiative units 32 and 33; however, either end of the metallic members 51 and 52 in the tube axis direction may be in electrical contact with the radiative unit 31 or the non-radiative units 32 and 33. In this case, the metallic members 51 and 52 are applied with current in the tube axis direction when applying current to the filament 3 and are not radiative and become radiative in the same way as the non-radiative unit 32. In this manner, decrease of the tube wall temperature of the bulb 2 in the non-radiative regions P2 and P3 can be suppressed due to the radiation of the metallic members 51 and 52 themselves in addition to the heat from the radiative region P1.

### Embodiment 2

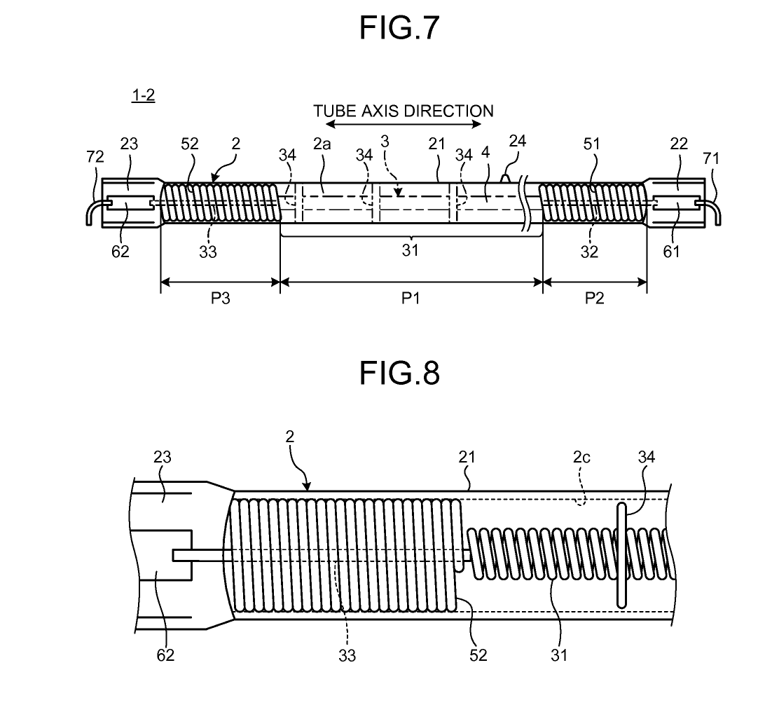

Next, Embodiment 2 will be described. FIG. 7 is a front view illustrating a halogen heater of Embodiment 2. FIG. 8 is a view illustrating a main part of the halogen heater of Embodiment 2.

The halogen heater 1-2 (hereinafter, simply referred to as a heater 1-2) of Embodiment 2 illustrated in FIG. 7 is different from the heater 1-1 of Embodiment 1 in that the non-radiative units 32 and 33 are configured of metallic wires.

As illustrated in FIG. 7 and FIG. 8, the non-radiative units 32 and 33 are metallic wires formed of tungsten and metallic wires having the same wire diameter as the radiative unit 31. The non-radiative units 32 and 33 according to Embodiment 2 are formed in a straight line along the tube axis and thus the electrical resistance becomes lower than in the radiative unit 31 which is formed by spirally winding the tungsten wire. In this manner, the non-radiative units 32 and 33 are not radiative relative to the radiative unit 31 when applying current. In addition, the non-radiative units 32 and 33 are formed to have substantially the same length as the metallic members 51 and 52 in the tube axis direction, similar to the heater 1-1 of Embodiment 1.

In addition, the heater 1-2 has regions of space in the inside portion 2a of the cylinder-like section 21 in which the non-radiative units 32 and 33 are disposed become the non-radiative regions P2 and P3, similar to the heater 1-1 of Embodiment 1.

Next, an example of manufacturing the heater 1-2 will be described. The heater 1-2 has an entire length L1 of 510 mm, a bulb tube diameter of 10 mm, an inner bulb diameter of 8 mm, an effective radiation length L2 of 480 mm, a length of the radiative region P1 of 280 mm in the tube axis direction, and a length of each of the non-radiative regions P2 and P3 of 100 mm in the tube axis direction. In addition, the heater 1-2 has a length of the radiative unit 31 of 280 mm in the tube axis direction (the same as the radiative region P1), an outer coil diameter of the radiative unit 31 of 5 mm, a wire diameter of the radiative unit 31 of 0.2 mm to 0.5 mm, a length of each of the non-radiative units 32 and 33 of 100 mm in the tube axis direction (the same as the non-radiative regions P2 and P3), and a wire diameter of the non-radiative units 32 and 33 of 0.2 mm to 0.5 mm (the same as the wire diameter of the radiative unit 31). In addition, the heater 1-2 has a length of each of the metallic members 51 and 52 of 100 mm (the same as the non-radiative units 32 and 33), an outer coil diameter of the metallic members 51 and 52 of 8 mm, and a wire diameter of the metallic members 51 and 52 of 0.6 mm.

In addition, when heater power is 1500 W, the heater 1-2 has a tube wall loading of 21.3 W/cm², a heater voltage of 235 V, and a heater current of 6.4 A.

Next, an operation of the heater 1-2 will be described. When power is supplied to the heater 1-2, the radiative unit 31 of the filament 3 and the non-radiative units 32 and 33 are applied with current in the tube axis direction and, the tube wall temperature of the bulb 2 in the radiative region P1 becomes a temperature at which the halogen cycle is promoted. The heat is conducted to the non-radiative regions P2 and P3 of the heater 1-2 from the radiative region P1 through the metallic members 51 and 52 and thereby, the tube wall temperature of the bulb 2 becomes the temperature at which the halogen cycle is promoted. Therefore, in the heater 1-2, the temperature decrease of the bulb 2 in the non-radiative regions P2 and P3 can be suppressed.

In addition, if an irradiation target is heated using the heater 1-2 mounted in a heating furnace, the heater 1-2 is supplied with power and the radiative region P1 has the tube wall temperature of the bulb 2 which reaches the temperature at which the halogen cycle is promoted and the non-radiative regions P2 and P3 have the tube wall temperature of the bulb 2 which reaches the temperature at which the halogen cycle is promoted. In addition, the non-radiative units 32 and 33 and the metallic members 51 and 52 are 5 cm or greater in length in the tube axis direction in the sealing sections 22 and 23 of the heater 1-2. Therefore, in the heater 1-2, the temperature decrease of the bulb 2 in the non-radiative regions P2 and P3 can be suppressed.

In Embodiment 2 described above, the non-radiative units 32 and 33 are the metallic wires formed of tungsten and are metallic wires having the same wire diameter as the radiative unit 31; however, as long as the non-radiative units 32 and 33 are not radiative relative to the radiative unit 31 when applying current, the non-radiative units 32 and 33 may be configured as a loosely wound coil such that an electrical resistance value becomes less than that of the radiative unit 31.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A halogen heater comprising:
a bulb;
a filament disposed in an inside portion of the bulb along a tube axis;
a gas filling the inside portion of the bulb; and
a thermally-conductive metallic member disposed in the inside portion of the bulb,
wherein the filament includes
a radiative unit which performs radiation when applying current, and
a non-radiative unit which is each disposed at either end of the radiative unit in the tube axis direction, which is electrically connected to the radiative unit, and which is not radiative relative to the radiative unit when applying current,
wherein the bulb includes
a radiative region in which the radiative unit is disposed, and
a non-radiative region in which the non-radiative unit is disposed,
wherein the metallic member is disposed in the non-radiative region.

2. The heater according to claim 1,
wherein the non-radiative unit and the metallic member are disposed to overlap each other in a radial view,
wherein the non-radiative unit is 5 cm or greater in length in the tube axis direction,
wherein the metallic member is 5 cm or greater in length in the tube axis direction, and
wherein the non-radiative unit and the metallic member are set to have substantially the same length in the tube axis direction.

3. The heater according to claim 1,
wherein the metallic member is configured as a closely wound coil.

4. The heater according to claim 1,
wherein the radiative unit has a coil which is formed by winding a wire, and
wherein the non-radiative unit has a metallic bar which is greater in diameter than the wire.

5. The heater according to claim 1,
wherein the radiative unit and the non-radiative unit are configured as separate members.

6. The heater according to claim 1,
wherein the non-radiative unit and the metallic member are disposed to overlap each other in a radial view,
wherein the non-radiative unit is 5 cm to 30 cm in length in the tube axis direction,
wherein the metallic member is 5 cm to 30 cm in length in the tube axis direction, and
wherein the non-radiative unit and the metallic member are set to have substantially the same length in the tube axis direction.

7. The heater according to claim 6,
wherein the non-radiative unit and the metallic member are formed to be different in length within 1 cm from each other in the tube axis direction.
